(19) United States
(12) Patent Application Publication
(10) Pub. No.: US 2010/0094849 A1
(43) Pub. Date: Apr. 15, 2010

(54) SYSTEMS AND METHODS FOR CREATING USER GENERATED CONTENT INCORPORATING CONTENT FROM A CONTENT CATALOG

(76) Inventors: Robert Rose, Ashburn, VA (US); Kelvin Hung, San Diego, CA (US); Camille Matthews, Silverdale, WA (US); Nichole Goodyear, San Diego, CA (US)

Correspondence Address: KAUTH , POMEROY , PECK & BAILEY ,LLP, 2875 MICHELLE DRIVE, SUITE 110, IRVINE, CA, 92606, US

(21) Appl. No.: 12/497,916

(22) Filed: Jul. 6, 2009

Related U.S. Application Data
(63) Continuation-in-part of application No. 11/893,765, filed on Aug. 17, 2007.
(60) Provisional application No. 61/078,243, filed on Jul. 3, 2008.

(51) Int. Cl. G06F 17/30; G06F 3/048

(52) U.S. Cl. 707/705; 715/764; 707/802; 707/E17.044; 707/E17.107

(57) ABSTRACT

Systems and methods for creating user generated content incorporating content from a content catalog are described. One embodiment of the invention includes a user generated content creation system, which includes a database, and is connected to a network, and a plurality of user devices that are connected to the network. In addition, the database contains a content catalog, the user generated content creation system is configured to dynamically create a user interface accessible via a user device, where the user interface enables a user device to create user generated content incorporating at least one piece of content from the content catalog, the user generated content creation system is configured to store a file containing user generated content created via the user interface on a storage device, and the user generated content creation system is configured to record information concerning content from the content catalog incorporated within the stored user generated content.

### CROSS REFERENCE TO RELATED APPLICATIONS

The present invention claims priority as a continuation-in-part of U.S. patent application Ser. No. 11/893,765 entitled “Online Marketing Platform” filed Aug. 17, 2007. The present invention also claims priority to U.S. Provisional Patent Application No. 61/078,243 entitled “Internet Based Multilingual Advertising Methods and Systems and Geographical Location Mapping Systems and Methods” filed Jul. 3, 2008. The disclosure of U.S. patent application Ser. No. 11/893,765 and U.S. Provisional Patent Application No. 61/078,243 is incorporated by reference herein in its entirety.

### BACKGROUND

The present invention relates generally to online marketing platforms and more specifically to online tools enabling the creation of user generated content incorporating content from an online content catalog.

Online marketing platforms such as the online marketing platform described in U.S. patent application Ser. No. 11/893,765 entitled “Online Marketing Platform” filed Aug. 17, 2007, enable the creation of online marketing campaigns that utilize viral sharing of user generated content. The disclosure of U.S. patent application Ser. No. 11/893,765 is incorporated by reference herein in its entirety. The term “user generated content” (UGC) is commonly used to refer to electronic media posted on the Internet by an individual. Examples of UGC include but are not limited to text posted in the form of a blog, audio posted in the form of a podcast, images posted as photos or graphic designs, video uploaded to a media sharing web site, various combinations of these forms of media, and other media types including SMS text messages, MMS messages, non-digital media, and new media types. A feature of UGC is that it typically relies upon viral distribution to reach its audience, often through content distribution platforms such as, but not limited to, Facebook, MySpace, Xanga, email, microblogs, blogs, social networks and other social media outlets that facilitate the distribution and exchange of UGC. “Viral distribution” is a term that is used to describe the distribution of information or media as a result of one to one or one to many interactions between individual users. U.S. patent application Ser. No. 11/893,765 describes campaigns hosted using online marketing platforms that are solicitations for UGC in response to a particular theme or idea. Rather than a single piece of UGC being the basis of a marketing campaign, the marketing campaign itself stimulates the generation of UGC and the online marketing platform then enables users to virally propagate the UGC and the campaign throughout the Internet in ways that encourage other users to interact and engage with the campaign.

A number of software applications exist for creating content that a user can post to the Internet as UGC. In many instances, the UGC is a composition of multiple pieces of content. For example, the UGC may be an image created as a digital collage of other images or include the combination of a video track and an audio track that are mashups of video and audio clips. The pieces of content used in the UGC can be created by a user or obtained from other sources. When the content is uploaded as UGC, other pieces of content incorporated within the UGC cannot be readily identified without inspecting the content of the UGC.

### SUMMARY OF THE INVENTION

Systems and methods are described that provide tools for creating User Generated Content (“UGC”) and which enable the incorporation of content from a content catalog into the User Generated Content. In a number of embodiments, a user generated content creation system is provided that enables users to create user generated content (“UGC”) incorporating content from a content catalog. In several embodiments, the user generated content creation system requires the inclusion of one or more pieces of content from the content catalog to complete the creation of piece of UGC. During the creation of the UGC, the user generated content creation system can record user interactions with specific pieces of content in the content catalog. In many embodiments, information recorded concerning an interaction includes the geographic location of the user. The recorded information can be aggregated based upon geographic location and displayed via a map. In addition to geographic location information users can use permissive based opt in to provide demographic (such as age, sex, personal preferences) and other personal information as well. For the subset of users who provide this information predictive modeling can be performed to obtain information pertinent to demographic age cells, which can assist in the development of marketing plans and other research and development.

In a number of embodiments, a content distribution platform is provided that enables users to interact with UGC, which incorporates content from a content catalog, as the UGC is virally distributed throughout the Internet. The content distribution platform can also record information concerning the user interactions with the UGC including the user's geographic location. The recorded information can be aggregated based upon geographic location and displayed via a map. In several embodiments, knowledge concerning content from the content catalog included in the UGC enables the aggregation of information concerning user interactions with specific pieces of content incorporated within UGC.

One embodiment of the invention includes a user generated content creation system, which includes a database, and is connected to a network, and a plurality of user devices that are connected to the network. In addition, the database contains a content catalog, the user generated content creation system is configured to dynamically create a user interface accessible via a user device, where the user interface enables a user device to create user generated content incorporating at least one piece of content from the content catalog, the user generated content creation system is configured to store a file containing user generated content created via the user interface on a storage device, and the user generated content creation system is configured to record information concerning content from the content catalog incorporated within the stored user generated content.

In a further embodiment of the invention, the user generated content creation system is configured to store a reference to the file containing the user generated content in the database.

In another embodiment of the invention, the information concerning content from the content catalog incorporated within user generated content created via the user interface is stored in the database.

In a still further embodiment of the invention, the information concerning content from the content catalog incorporated within the user generated content created via the user interface is stored as metadata.

In still another embodiment of the invention, the metadata is stored in the file containing the user generated content.

In a yet further embodiment of the invention, the user generated content creation system is configured to record in the database requests received from a user device related to a piece of content in the content catalog during the creation of the user generated content via the user interface.

In yet another embodiment of the invention, the user generated content creation system is configured to aggregate the records of requests from a user device related to a piece of content in the content catalog.

In a further additional embodiment of the invention, the user generated content creation system is configured to perform predictive modeling based upon the aggregated records.

In another additional embodiment of the invention, the user generated content creation system is configured to obtain the geographic location of a user device, and records of requests from a user device in the database include the geographic location of the user device that made the request.

In a further embodiment again of the invention, the user generated content creation system is configured to aggregate the records of requests from a user device based upon geographic location.

In another embodiment again of the invention, the user generated content creation system is configured to perform geographic location based predictive modeling using the aggregated records.

In a still yet further embodiment of the invention, the user generated content creation system is configured to generate markers using the aggregated records that are provided to a mapping application, and to dynamically generate a user interface incorporating a map generated by the mapping application that includes the markers.

In still yet another embodiment of the invention, the user generated content creation system is configured to provide access to the stored user generated content via a dynamically generated user interface in response to a request from a user device.

A still further additional embodiment of the invention, also includes information related to content in the content catalog stored in the database. In addition, the user generated content creation system is configured to dynamically generate a user interface that provides access to stored user generated content and information related to content from the content catalog incorporated in the stored user generated content.

In still another additional embodiment of the invention, the user generated content creation system is configured to retrieve information concerning the content that is incorporated within a piece of user generated content and to identify information related to the incorporated content.

In a still further embodiment again of the invention, the user generated content creation system is configured to retrieve information concerning the content that is incorporated within a piece of user generated content from the database.

In still another embodiment again of the invention, the user generated content creation system is configured to retrieve information concerning the content that is incorporated within a piece of user generated content from metadata.

In a yet further additional embodiment of the invention, the metadata is located within the file containing the user generated content.

In yet another additional embodiment of the invention, the user generated content creation system is configured to record in the database requests received from a user device related to a piece of stored user generated content.

In a yet further embodiment again of the invention, the user generated content creation system is configured to aggregate the records of requests from a user device related to pieces of stored user generated content based upon content from the content catalog incorporated in each piece of user generated content.

In yet another further embodiment again of the invention, the user generated content creation system is configured to perform predictive modeling based upon the aggregated records.

In further additional embodiment again of the invention, the user generated content creation system is configured to obtain the geographic location of a user device, and records of requests from a user device in the database include the geographic location of the user device that made the request.

In another additional embodiment again of the invention, the user generated content creation system is configured to aggregate the records of requests from a user device based upon geographic location.

In another further embodiment of the invention, the user generated content creation system is configured to generate markers using the aggregated records that are provided to a mapping application, and to dynamically generate a user interface incorporating a map generated by the mapping application that includes the markers.

In still another further embodiment of the invention, the user generated content creation system is configured to aggregate the records of requests from a user device based upon geographic location and based upon content from the content catalog incorporated in each piece of user generated content.

In yet another further embodiment of the invention, the user generated content creation system is configured to perform geographic location based predictive modeling based upon the aggregated records.

In another further additional embodiment of the invention, the user generated content creation system is configured to generate markers using the aggregated records that are provided to a mapping application, and to dynamically generate a user interface incorporating a map generated by the mapping application that includes the markers.

An embodiment of the method of the invention includes providing a content catalog accessible via a storage device, creating user generated content incorporating content from the content catalog via a user interface dynamically generated by a user generated content creation system configured to communicate with the storage device, storing information indicative of the created user generated content and content from the content catalog incorporated in the user generated content in a database, and dynamically generating a user interface using a content distribution platform configured to communicate with the storage device, where the user interface provides access to the stored user generated content and information related to content that is incorporated within the user generated content.

### BRIEF DESCRIPTION OF THE DRAWINGS

FIG. 1 is a network diagram showing a system configured to enable the creation of UGC including content from a content catalog, where the system includes a user generated content creation system connected to user devices via a network in accordance with an embodiment of the invention.

FIG. 2 is a screen shot of a user interface for creating UGC that incorporates content from a content catalog in accordance with an embodiment of the invention.

FIG. 3 is a screen shot of a user interface showing images from a first category in a content catalog and the incorporation of a selected piece of content from the first category into a piece of UGC in accordance with an embodiment of the invention.

FIG. 4 is a screen shot of a user interface showing images from a second category in a content catalog and the incorporation of a selected piece of content from the second category into the piece of UGC illustrated in FIG. 3 in accordance with an embodiment of the invention.

FIG. 5 is a screen shot of a user interface showing images from a third category in a content catalog and the incorporation of a selected piece of content from the third category into the piece of UGC illustrated in FIG. 4 in accordance with an embodiment of the invention.

FIG. 6 is a screen shot of a user interface showing images from a fourth category in a content catalog and the incorporation of multiple pieces of content from the fourth category into the piece of UGC illustrated in FIG. 5 in accordance with an embodiment of the invention.

FIG. 7 is a flow chart illustrating a process for tracking user interactions with content in a content catalog during the creation of UGC in accordance with an embodiment of an invention.

FIG. 8 is a partial screen shot of a user interface showing a piece of UGC incorporating content from a content catalog and displaying additional information associated with pieces of content from the content catalog incorporated into the UGC in accordance with embodiments of the invention.

FIG. 9 is a flow chart showing a process for retrieving information related to content incorporated in a piece of UGC for use in the dynamic generation of a user interface in accordance with an embodiment of the invention.

FIG. 10 is a partial screen shot of a user interface incorporating a map illustrating tracked user engagements with a piece of UGC, where the tracked user engagements are aggregated based upon geographic location in accordance with an embodiment of the invention.

### DETAILED DESCRIPTION OF THE INVENTION

Turning now to the drawings, systems and methods are described that enable the creation of User Generated Content (“UGC”) and which enable the incorporation of content from a content catalog into the UGC. The content catalog can include, but is not limited to, pieces of text, images, audio clips, and/or video clips. In many embodiments, at least some of the content within the content catalog relates to a good or service. In several embodiments, creation of UGC requires incorporating within the UGC predetermined numbers of pieces of content from within at least one category of a the content catalog. In a number of embodiments, UGC can also be created that incorporates content generated by the user (i.e. content not found in the content catalog).

Interactions associated with the selection of content from the content catalog can be tracked. In several embodiments, the tracked information includes the geographic location of the user interacting with the content from the content catalog. Tracked information concerning user interactions with content from the content catalog can be aggregated. In a number of embodiments, user interactions with specific pieces of content based upon geographic location can be aggregated. In many embodiments, aggregated information based upon geographic location can be graphically displayed on a map and/or used to perform predictive modeling.

When UGC incorporating content from a content catalog is uploaded to a content distribution platform, such as but not limited to an online marketing platform, in accordance with an embodiment of the invention, the content from the content catalog contained within the UGC is known. Aggregating tracked engagement with UGC containing content from the content catalog as the UGC is virally distributed provides information concerning relationships between specific pieces of content incorporated in UGC and the type and/or frequency of user interactions. In many embodiments, the content distribution platform tracks information including the geographic location of users interacting with the UGC. The tracked information enables the aggregation of user interactions with a group of UGC such as submission in an online marketing campaign, with specific pieces of UGC, and/or UGC containing specific pieces of content from a content catalog based upon geographic location. In several embodiments, the aggregated information based upon geographic location is graphically displayed on a map and/or used to perform predictive modeling.

### User Generated Content Creation Systems

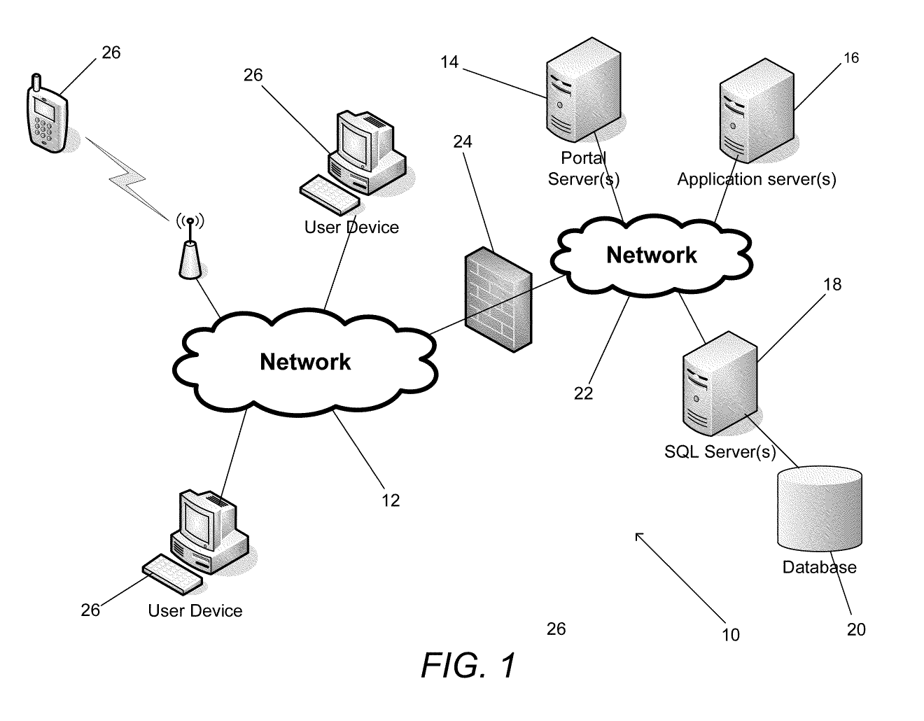

A system configured to enable the creation of UGC including content from a content catalog is illustrated in FIG. 1. The system 10 includes a user generated content creation system connected to the Internet 12. In the illustrated embodiment, the user generated content creation system is implemented using a portal server 14, an application server 16 and a database management system 18 connected to a database 20, and the portal server, application server and database management system communicate via a local network 22. In several embodiments, multiple portal servers, multiple application servers and/or multiple database management systems can be utilized in combination with a load balancer. The local network is typically connected to the Internet via some type of firewall 24 and the user generated content creation system uses the connection to the Internet to communicate with user devices 26. A user device can be any device that is configured to display user interfaces provided by the portal server and can include but is not limited to a personal computer, a mobile phone handset, a set top box, or a gaming console.

In the illustrated embodiment, the user devices 26 communicate with the portal server 14 and the portal server dynamically generates user interfaces using information obtained from the database 20 via the database management system 18 in response to requests from the user devices. In a number of embodiments, the user interface provided by the portal server enables the creation of UGC incorporating content from a content catalog. The content catalog is typically stored in the database 20, but can be stored elsewhere including in a distributed fashion across the Internet (e.g. the catalog can reference multiple pieces of content accessible via different sites). The content catalog typically includes but is not limited to, pieces of text, images, audio clips, and/or video clips. The user interface can also enable incorporation of pieces of content uploaded by the user device into the UGC. In many embodiments, the user generated content creation system requires the inclusion of at least one piece of content from the content catalog into the UGC. In a number of embodiments, the content catalog can include multiple categories and the user generated content creation system requires inclusion of at least one piece of content from each category. In a typical example, UGC is created using images uploaded from a user device and images contained in a content catalog. In many embodiments, the images relate to goods or services that are sold by a particular company or that are available via a specific online retail website. In such an example, inclusion of images from the content catalog can provide an effect analogous to product placement in conventional media. As the UGC is virally distributed, the images of selected goods or services are also distributed. In many embodiments, the user device can also access information concerning the selected goods and services in conjunction with accessing the UGC.

Referring back to FIG. 1, UGC created using the user generated content creation system is stored in the database 20. In many embodiments, the user generated content creation system is part of a platform that enables the viral distribution of the UGC stored in the database. In several embodiments, the UGC can be accessed via and/or shared with other platforms that enable the viral distribution of the UGC. As is discussed further below, the content from a content catalog incorporated in UGC created using the user generated content creation system is known. Therefore, a user device accessing the UGC can obtain additional information related to content from the content catalog, which was incorporated into the UGC. In a number of embodiments, the UGC and information that can be used to access information related to the content from the content catalog incorporated in the UGC is stored in a database of a content distribution platform that can facilitate the viral distribution of the UGC and enable user devices to access the related information via a user interface. In many embodiments, information that can be used to access the related information is encoded into the UGC by the user generated content creation system as metadata, and the related information is accessible irrespective of the platform used to distribute the UGC.

During the creation of UGC incorporating content from a content catalog, the portal server 14 receives requests from a user device 26. The application server 16 can track the requests and record information concerning the interactions between the user device and content from the content catalog in the database. The types of interactions that can be tracked by the application server include but are not limited to scrolling over a piece of catalog in the content catalog, viewing pieces of content in the content catalog, incorporating the content in the UGC (irrespective of whether the content is utilized in the final UGC), and/or the content incorporated into the finalized UGC. The term “scroll over” describes accessing additional information by hovering over a piece of content in the content catalog presented in the user interface to access additional information. The term “view” is used here to describe the act of accessing a page that includes information concerning a piece of content from the content catalog.

In many embodiments, the application server 16 tracks the geographic location of the user that interacts with the portal server. The geographic location can be determined in a number of ways including but not limited to information provided in a user profile, information directly provided by the user, information indicative of geographic location inherent in the manner in which the user device communicates via the Internet, and/or cookie tracking. In a number of embodiments, each user device is assigned a unique network address (typically an I.P. address) to enable communication with the device via the Internet. Services exist that enable the mapping of an I.P address to a geographic location. Therefore, the application server can capture the I.P. address of the user device and access a service to map the I.P address to a geographic location. The geographic location can be verified using information provided by the user and/or information obtained by cookie tracking. When information is recorded in the database concerning interactions between user devices and content from the content catalog, the geographic location of the user devices can be associated with the interactions. In several embodiments, the application server can aggregate information concerning interactions with pieces of content from the content catalog based upon geographic location. When the content in a content catalog relates to goods or services, the aggregated information can be used to perform predictive modeling concerning likely demand for the goods and general consumer trends. Incorporating geographic location into the aggregated data enables predictive modeling and analysis for general trends at different levels of granularity based upon geographic location. In many embodiments, information aggregated based upon geographic location can be displayed on a map.

Similar techniques to those described above can be used to track the geographic location of users engaging with UGC in accordance with embodiments of the invention. Systems and methods for tracking engagement with UGC are described in U.S. patent application Ser. No. 11/893,765, the disclosure of which is incorporated by reference in its entirety above. When UGC incorporates content from a content catalog in the manner outlined above, tracked information concerning engagement with UGC can be aggregated based upon the content from the content catalog incorporated in the UGC. The aggregated information can provide additional information for use in predictive modeling and analysis of general trends. The tracked information can also be aggregated based upon geographic location to provide different levels of granularity when performing predictive modeling and analysis of general trends. In many embodiments, information aggregated based upon geographic location can be displayed on a map. The creation of UGC incorporating content from a content catalog, the tracking of interactions with content from the content catalog and with UGC incorporating content from the content catalog, and the aggregation of tracked information based upon geographic location is discussed further below.

### Creation of UGC Using a Content Catalog

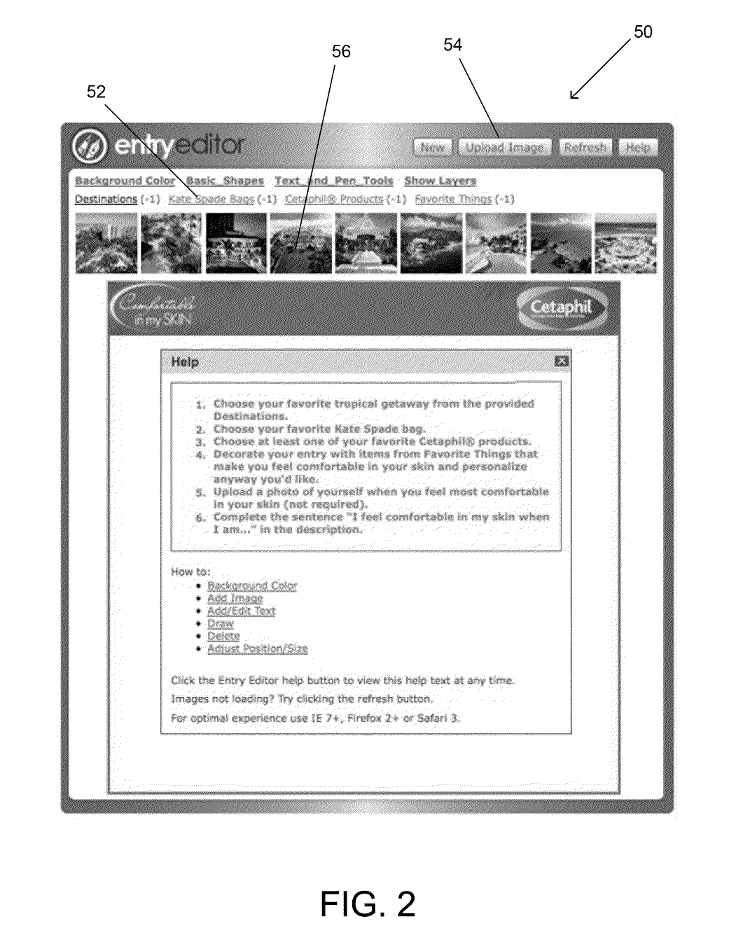

A variety of user interfaces can be used in accordance with embodiments of the invention to enable the creation of UGC incorporating content from a content catalog. Typically, the nature of the user interface generated by a user generated content creation system depends upon the type of UGC being created and the nature of the content provided in the content catalog. A user interface for creating an image file incorporating images from a catalog of images is illustrated in FIG. 2. The screen shot 50 shown in FIG. 2 shows a user interface that can be used to generate UGC incorporating content from a content catalog in accordance with an embodiment of the invention. The user interface enables the creation of UGC by combining content from the different categories 52 in the content catalog with text, drawing took, and shapes. The user interface also provides a mechanism 54 for the uploading of user content.

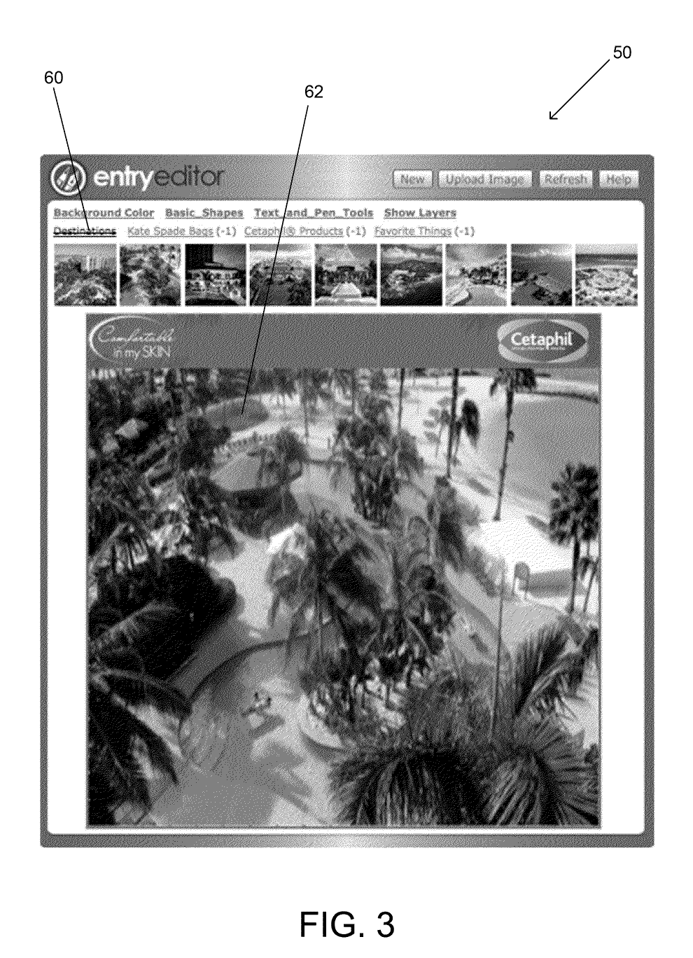

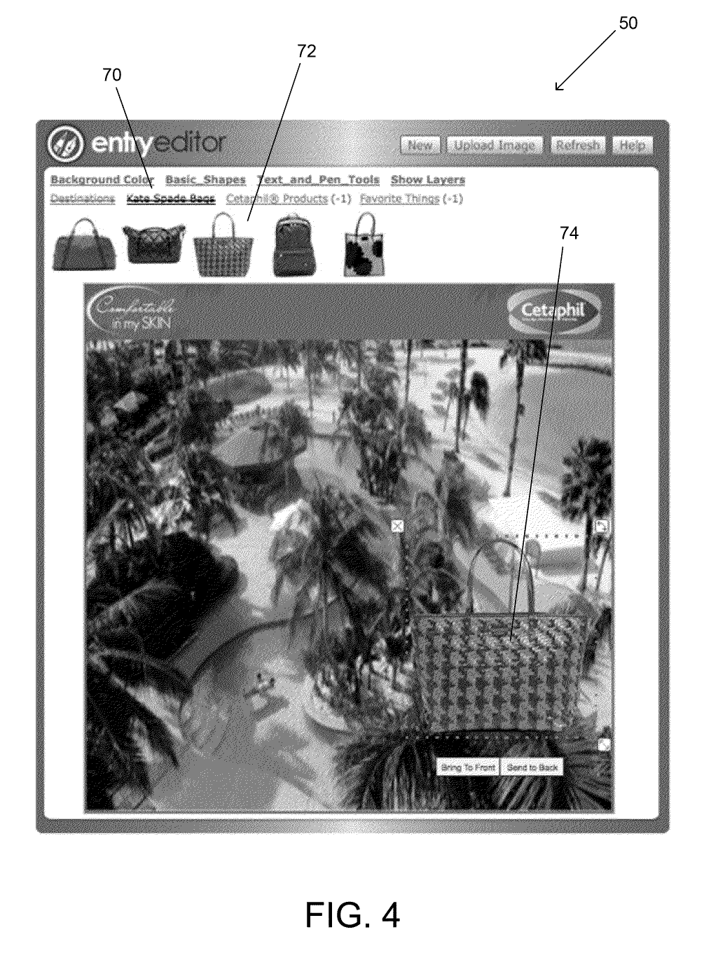

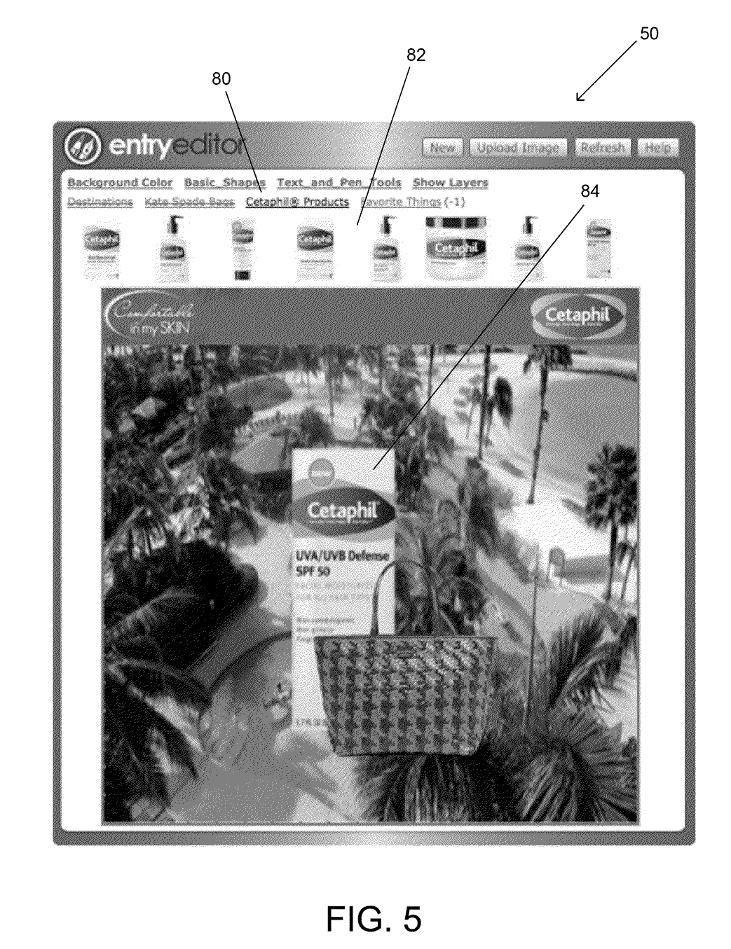

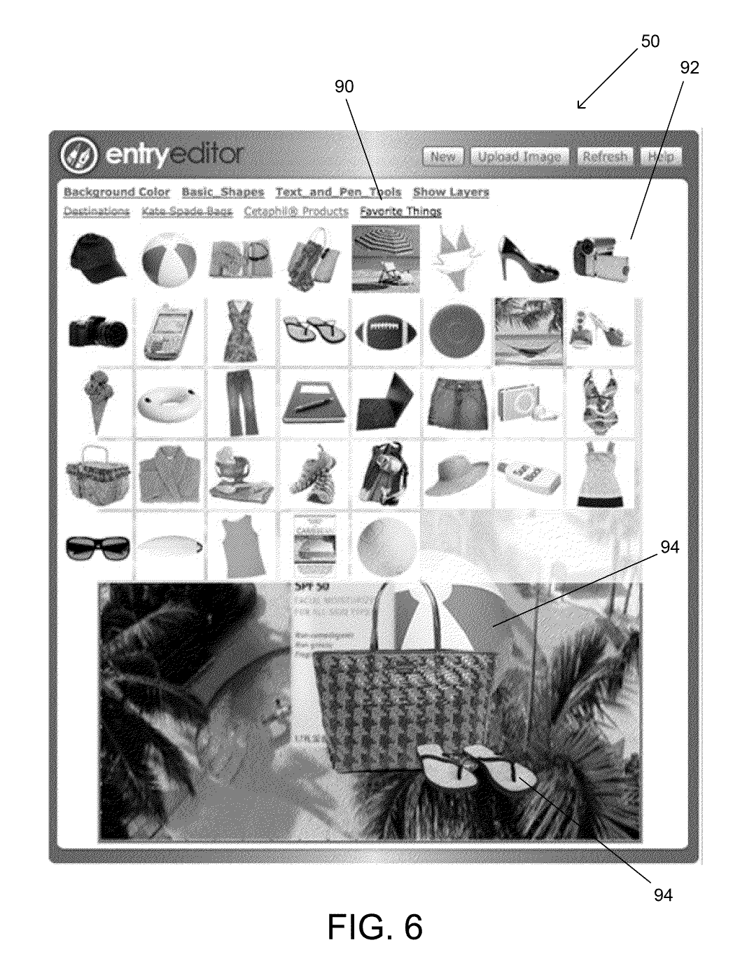

In the illustrated embodiment, the content catalog includes four categories 52 “Destinations”, “Kate Spade Bags”, “Cetaphil Products”, and “Favorite Things”. The category “Destinations” is selected and a number of images 56 from within the content catalog are displayed. The user interface can limit the number of pieces that can be selected from a specific category in the content catalog. As can be seen in FIG. 3, a single selection is allowed from the “Destinations” category 60 and the selection of an image 62 from that category results in the user interface preventing selection of a second piece of content from the “Destinations” category, which is illustrated as struck through. Content from the other categories can then be selected. A screen shot of the user interface when the “Kate Spade Bags” category 70 is selected is illustrated in FIG. 4. The screen shot shows a number of images 72 of bags from within the content catalog. Again, the user interface limits the user device to selection of a single image 74. Once the image is selected, the category is struck through to indicate that the maximum number of pieces of content have been selected. The selection of an image 80 from a group of images 82 in the “Cetaphil Products” category 84 and the incorporation of the selected image into the UGC is shown in FIG. 5. In many instances, the user interface enables the selection of multiple or unlimited pieces of content from within a content category. A screen shot of the user interface when the “Favorite Things” category 90 is selected is shown in FIG. 6. The “Favorite Things” category includes a significantly larger number of images 92 and multiple images 94 selected from the category can be incorporated into the UGC. When all of the desired components are incorporated into the UGC, the user interface enables the UGC to be saved for sharing with other user devices. In many instances, the user interface requires that a specified number of pieces of content from specified categories within the content catalog be included in the UGC before the UGC can be shared with other user devices. Although a specific user interface is described above, other user interfaces in accordance with embodiments of the invention can be used to enable the creation of UGC incorporating content from a content catalog.

Tracking Interactions with Content from a Content Catalog

As a user device interacts with a user interface during the creation of UGC, the user device sends messages or requests to the user generated content creation system including but not limited to requests associated with viewing, selecting, and manipulating content in a content catalog. The user generated content creation system processes the requests and updates the user interface accordingly. Many of the requests are not directly associated with the creation of UGC. For example, requests can simply involve the user browsing content in the content catalog. The requests received from user devices by the user generated content creation system can be used by the user generated content creation system to track different types of user interactions with different pieces of content within the content catalog.

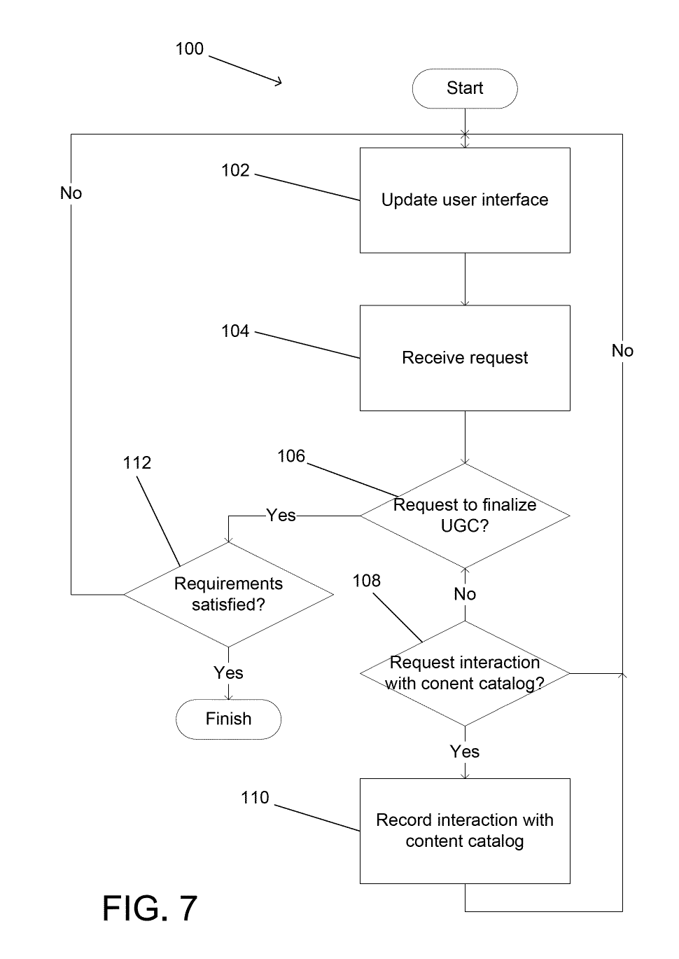

A process for tracking user interactions with content in a content catalog during the creation of UGC in accordance with an embodiment of the invention is illustrated in FIG. 7. The process 100 includes using a user generated content creation system to provide (102) a user interface to an appropriately configured user device, where the user device can interact with content in a content catalog via the user interface by sending predetermined requests to the user generated content creation system. Upon receipt (104) of a request from a user device, the user generated content creation system determines (106) whether the request indicates that the UGC is complete. When the request does not indicate that the UGC is complete, a determination (108) is made concerning whether the request involves an interaction with content from the content catalog. When the interaction involves an interaction with content from the content catalog, a record of the interaction (110) is made and the user interface is updated (102) in accordance with the request. When the interaction does not involve an interaction with content from the content catalog, the user interface is simply updated (102) in accordance with the request. In a number of embodiments, a request to finalize the UGC prompts the system to determine (112) whether predetermined requirements are satisfied. In many embodiments, the UGC must include at least one piece of content from at least one category in the content catalog prior to posting the UGC for access via the Internet. In other embodiments, other requirements can be imposed upon the UGC in accordance with a specific application. In the event that the requirements are satisfied, then the UGC is finalized and posted for access via the Internet. In the event that the UGC does not satisfy the requirements, then the user interface is updated (102) accordingly. Although a specific process is described above, other processes including but not limited to processes that do not impose requirements on the UGC and/or process that only track the content from the content catalog incorporated in the final piece of UGC can be used during the creation of UGC in accordance with embodiments of the invention.

### Obtaining Geographic Location of Users

When a request is received from a user, the geographic location of the user can be determined. In a number of embodiments, the geographic location is determined using one or more of a variety of techniques including but not limited to a reverse look up of an IP address, cookie tracking, and/or automatically from a user profile and/or user device or information directly provided by a user. In many embodiments, geographic location is determined using a first method such as a reverse I.P. address lookup and verified using a second source of geographic location information such as a user profile or a GPS co-ordinate provided by a user device. When geographic location information is known, records concerning specific interactions with content in a content catalog can be supplemented with geographic location information. Although specific techniques for determining the geographic location of a user device are described above, other techniques in accordance with the capabilities of the user device and the requirements of the application can be utilized in accordance with embodiments of the invention.

### Aggregating Interactions

Records of interactions with content in a content catalog made in accordance with embodiments of the invention can be aggregated to provide information concerning total numbers of interactions with specific pieces of content in the content catalog. In embodiments where information concerning the geographic location of the user that initiated an interaction is available, information concerning interactions with content in a content catalog can be aggregated based upon geographic location. The aggregated information can be used to perform predictive modeling and analysis for general trends with respect to content in the content catalog. In many embodiments, the aggregated geographic data is exportable to enable the manipulation of the aggregated data.

### Mapping Aggregated Interactions

Displaying information aggregated based on geographic location on a map can facilitate the visualization of the aggregated information. In a number of embodiments, information concerning interactions with content in a content catalog is aggregated based upon geographic location and then formatted for display on a map. In several embodiments, appropriately formatted marker data describing the aggregated information is provided to a mapping application via an API. The Google Maps API provided by Google, Inc. of Mountain View, Calif. is an example of an API that can be used to map markers indicative of aggregated information. In many embodiments, other mapping applications can be used to display the aggregated information.

Distribution Platforms and UGC Incorporating Content from a Content Catalog

In a number of embodiments, a user generated content creation system is part of a content distribution platform that can be used to virally distribute UGC such as an online marketing platform similar to the online marketing platforms described in U.S. patent application Ser. No. 11/893,765, the disclosure of which is incorporated by reference above. Other examples of content distribution platforms include the Facebook service provided by Facebook, Inc. of Palo Alto, Calif. UGC created using the user generated content creation system that is part of a content distribution platform is stored in a database and the content distribution platform provides access to the UGC and facilitates the viral distribution of the UGC.

### Accessing Information Related to Content Incorporated in UGC

When a content distribution system has knowledge of content incorporated within a piece of UGC, the content distribution system can provide a user with access to additional information concerning the content incorporated within the UGC. In a number embodiments, UGC incorporating content from a content catalog is stored in a database that also stores information concerning the content incorporated within the UGC, and additional information related to the incorporated content. When the content distribution system displays the UGC, the content distribution system can identify content from a content catalog incorporated in the UGC and provide access to additional information concerning the content incorporated in the UGC. In many embodiments, information concerning incorporated content and related information is stored in the database by creating a relationship within the database between the UGC and pieces of content in the content catalog that are in turn related to sources of relevant information. In several embodiments information concerning incorporated content and/or related information is stored as metadata either within the file containing the UGC or in a location referenced by the file containing the UGC. When information is incorporated as metadata, the information travels with the file and can be used by multiple content distribution systems to access information related to content incorporated within the UGC.

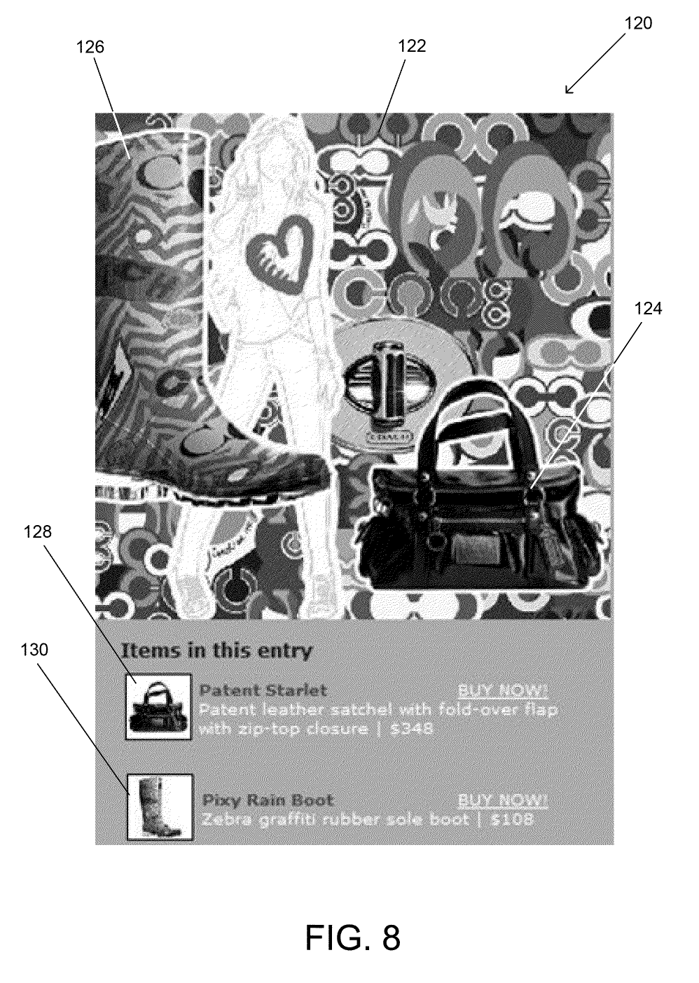

A partial screen shot of a user interface displaying a piece of UGC and information related to images incorporated in the UGC is illustrated in FIG. 8. The user interface 120 includes a piece of UGC 122 created using a collage of images. Included in the collage is an image of a satchel 124 and a rain boot 126. The user interface 120 also includes information 128 concerning the satchel and information 130 concerning the rain boot. The information related to the images incorporated into the piece of UGC includes the image originally incorporated in the UGC from a content catalog, the name of the item, information concerning the item and a link to a site where the item can be purchased. Although the information concerning the incorporated content is presented with the UGC in the illustrated embodiment, many user interfaces in accordance with embodiments of the invention present the information based upon engagement of the user with content in the UGC. In a number of embodiments, the information is presented when a user hovers over a piece of content incorporated in a piece of UGC. In several embodiments, the information is a URL that is utilized when a user clicks upon a region related to content incorporated within a piece of UGC. In UGC that is presented in accordance with a time sequence, such as audio and/or video, information related to content incorporated within the UGC can be displayed via a user interface in a pop-up or by clicking through regions of the UGC related to the incorporated content.

Content distribution platforms typically dynamically generate user interfaces, which involves dynamically generating code incorporating references, such as URLs, that enable a user device to retrieve different pieces of content incorporated within the user interface. The different pieces of content referenced by the user interface can be obtained from one or more locations. With reference to the user interface illustrated in FIG. 8, a content distribution platform can create a similar user interface by retrieving a references to a piece of UGC 122, and information 128, 130 related to content incorporated in the piece of UGC. The references are then included into a dynamically generated page that is provided to a user device, which uses the references to retrieve the piece of UGC and the related information for display within the formatted page.

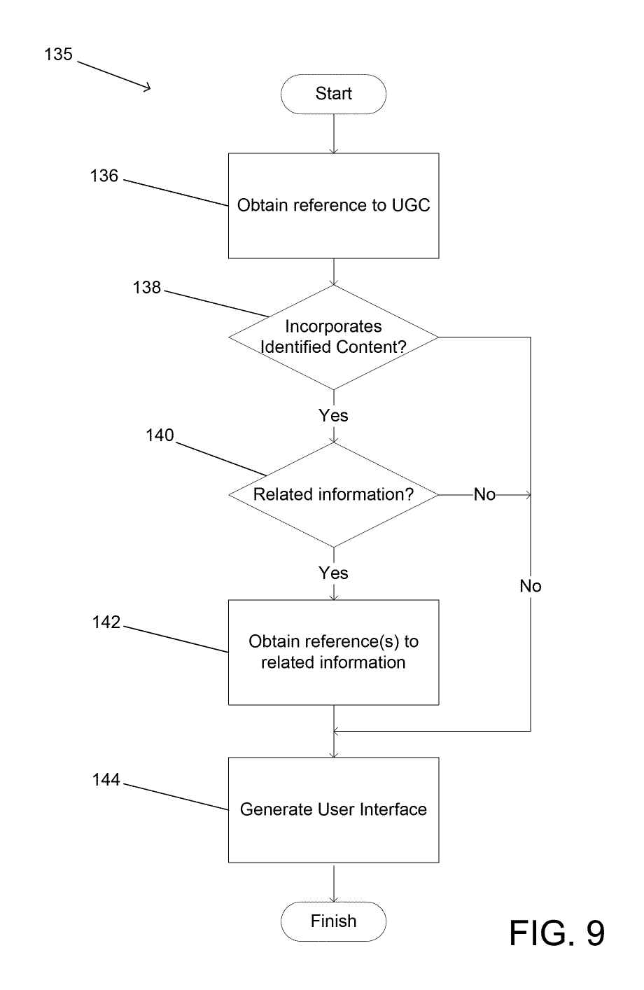

A process for retrieving information related to content incorporated within a piece of UGC during the dynamic generation of a user interface by a content distribution platform in accordance with an embodiment of the invention is illustrated in FIG. 9. The process 135 commences when a request is made to view a piece of UGC. The process involves obtaining (136) a reference to a requested piece of UGC and determining (138) whether the referenced piece of UGC incorporates any content. In a number of embodiments, content incorporated in the UGC is identified by references in the database of the content distribution system to content stored on the content distribution system, such as content from a content catalog, and/or to content located elsewhere. In many embodiments, content incorporated in the UGC is referenced by metadata and the content distribution system retrieves the file containing the UGC and extracts references to incorporated content from metadata within the file and/or retrieves references to incorporated content from metadata that is referenced by the file containing the UGC. Once references to incorporated content have been obtained, a determination (140) can be made concerning whether any information related to the incorporated content is available. When the incorporated content is from a content catalog, the content catalog can contain and/or identify sources of information related to the incorporated content. Once the information/references to related information are obtained (142), the references to the UGC, and the information/references to information related to content incorporated in the UGC can be used to dynamically (144) generate a user interface. Although a specific process is illustrated above, other techniques for dynamically generating a user interface displaying UGC and information related to content incorporated in the UGC can be utilized in accordance with the nature of a specific content distribution system and/or other requirements of a specific application.

### Tracking Content Incorporated in UGC

U.S. patent application Ser. No. 11/893,765 describes ways in which content distribution platforms can track engagement with UGC. Information concerning content from a content catalog incorporated into pieces of UGC can be used to aggregate records collected by content distribution platforms concerning engagement with UGC based upon the pieces of content from the content catalog that are incorporated in the UGC. In embodiments where information concerning content incorporated in UGC is stored in the database containing the UGC, aggregation can be performed by retrieving information concerning content contained within each piece of UGC from the database. When information concerning content incorporated in UGC is contained in metadata, the file containing each piece of content can be inspected to retrieve information concerning the content incorporated in each piece of UGC from the metadata. Content distribution systems can also directly track engagement with information related to content incorporated with UGC, where such information is displayed via the user interface, and the tracked information aggregated for use in predictive modeling and in analysis for general trends.

### Mapping Aggregated Interactions

Records of tracked engagement that include the geographic location of the user device that enabled the engagement with the UGC, can be aggregated based upon the pieces of content from the content catalog that are incorporated in the UGC and/or based upon the geographic location of the user device that enabled the engagement with the UGC/content from the content catalog. The aggregated data can then be used in predictive modeling and analysis for general geographic trends.

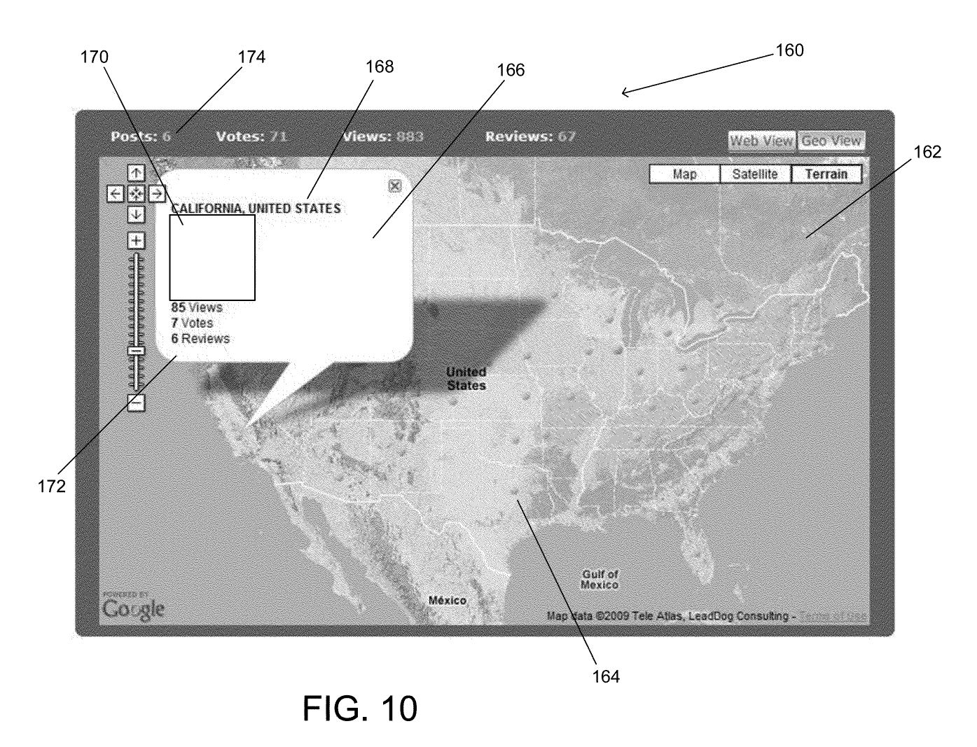

A partial screen shot of a user interface incorporating a map showing aggregated engagement with a piece of UGC in accordance with an embodiment of the invention is illustrated in FIG. 10. The user interface 160 includes a map 162 generated using the Google Maps API. The map 162 includes a number of custom markers 164 overlaid onto the map that enable the display of pop-up overlays 136 including information aggregated based upon geographic location. In the illustrated embodiment, the pop-overlays display a geographic location 168, an image 170 indicative of the UGC, and different forms of engagement 172 with the UGC that originated from the geographic location. The user interface also includes the overall aggregated totals 144 for different forms of engagement. Although a specific user interface is described, various techniques for illustrating information aggregated based upon geographic location using a map can be utilized in accordance with the requirements of specific applications.

### Predictive Modeling

Aggregated information concerning content incorporated in UGC can be used in any of a variety of predictive modeling techniques. For example, the aggregated information can be used to determine the top items chosen from each category in a content catalog. In embodiments where the UGC is a submission in an online marketing campaign, aggregated information concerning content from a content catalog that was popular can be analyzed to formulate broader marketing efforts. In addition, the ability to aggregate information based upon geographic location and/or based upon demographic information where such information is available (permission may be required from users to share such information) can provide the entity conducting the marketing campaign with more granular information concerning consumer preferences in different regions and/or across different demographics. Although specific examples of techniques for using aggregated information are described above, a variety of predictive modeling techniques in accordance with embodiments of the invention can be used to determine trends from aggregated information in accordance with the requirements of a specific application.

While the above description contains many specific embodiments of the invention, these should not be construed as limitations on the scope of the invention, but rather as an example of one embodiment thereof. For example, much of the discussion above refers to content catalogs being stored in the database of a user generated content creation system. In many embodiments, the content catalog is accessed by the user generated content creation system via the Internet. Accordingly, the scope of the invention should be determined not by the embodiments illustrated, but by the appended claims and their equivalents.

What is claimed is:

1. A system for creating user generated content incorporating content from an online content catalog, comprising:
a user generated content creation system, which includes a database, and is connected to a network; and
a plurality of user devices that are connected to the network;
wherein the database contains a content catalog;
wherein the user generated content creation system is configured to dynamically create a user interface accessible via a user device, where the user interface enables a user device to create user generated content incorporating at least one piece of content from the content catalog;
wherein the user generated content creation system is configured to store a file containing user generated content created via the user interface on a storage device; and
wherein the user generated content creation system is configured to record information concerning content from the content catalog incorporated within the stored user generated content.

2. The system of claim 1, wherein the user generated content creation system is configured to store a reference to the file containing the user generated content in the database.

3. The system of claim 2, wherein the information concerning content from the content catalog incorporated within user generated content created via the user interface is stored in the database.

4. The system of claim 2, wherein the information concerning content from the content catalog incorporated within the user generated content created via the user interface is stored as metadata.

5. The system of claim 4, wherein the metadata is stored in the file containing the user generated content.

6. The system of claim 1, wherein the user generated content creation system is configured to record in the database requests received from a user device related to a piece of content in the content catalog during the creation of the user generated content via the user interface.

7. The system of claim 6, wherein the user generated content creation system is configured to aggregate the records of requests from a user device related to a piece of content in the content catalog.

8. The system of claim 7, wherein the user generated content creation system is configured to perform predictive modeling based upon the aggregated records.

9. The system of claim 6, wherein:
the user generated content creation system is configured to obtain the geographic location of a user device; and
records of requests from a user device in the database include the geographic location of the user device that made the request.

10. The system of claim 9, wherein the user generated content creation system is configured to aggregate the records of requests from a user device based upon geographic location.

11. The system of claim 10, wherein the user generated content creation system is configured to perform geographic location based predictive modeling using the aggregated records.

12. The system of claim 10, wherein the user generated content creation system is configured to generate markers using the aggregated records that are provided to a mapping application, and to dynamically generate a user interface incorporating a map generated by the mapping application that includes the markers.

13. The system of claim 1, wherein the user generated content creation system is configured to provide access to the stored user generated content via a dynamically generated user interface in response to a request from a user device.

14. The system of claim 13, further comprising:
information related to content in the content catalog stored in the database;
wherein the user generated content creation system is configured to dynamically generate a user interface that provides access to stored user generated content and information related to content from the content catalog incorporated in the stored user generated content.

15. The system of claim 14, wherein the user generated content creation system is configured to retrieve information concerning the content that is incorporated within a piece of user generated content and to identify information related to the incorporated content.

16. The system of claim 15, wherein the user generated content creation system is configured to retrieve information concerning the content that is incorporated within a piece of user generated content from the database.

17. The system of claim 15, wherein the user generated content creation system is configured to retrieve information concerning the content that is incorporated within a piece of user generated content from metadata.

18. The system of claim 17, wherein the metadata is located within the file containing the user generated content.

19. The system of claim 13, wherein the user generated content creation system is configured to record in the database requests received from a user device related to a piece of stored user generated content.

20. The system of claim 19, wherein the user generated content creation system is configured to aggregate the records of requests from a user device related to pieces of stored user generated content based upon content from the content catalog incorporated in each piece of user generated content.

21. The system of claim 20, wherein the user generated content creation system is configured to perform predictive modeling based upon the aggregated records.

22. The system of claim 19, wherein:
the user generated content creation system is configured to obtain the geographic location of a user device; and
records of requests from a user device in the database include the geographic location of the user device that made the request.

23. The system of claim 22, wherein the user generated content creation system is configured to aggregate the records of requests from a user device based upon geographic location.

24. The system of claim 23, wherein the user generated content creation system is configured to generate markers using the aggregated records that are provided to a mapping application, and to dynamically generate a user interface incorporating a map generated by the mapping application that includes the markers.

25. The system of claim 22, wherein the user generated content creation system is configured to aggregate the records of requests from a user device based upon geographic location and based upon content from the content catalog incorporated in each piece of user generated content.

26. The system of claim 25, wherein the user generated content creation system is configured to perform geographic location based predictive modeling based upon the aggregated records.

27. The system of claim 26, wherein the user generated content creation system is configured to generate markers using the aggregated records that are provided to a mapping application, and to dynamically generate a user interface incorporating a map generated by the mapping application that includes the markers.

28. A method of distributing user generated content and information related to content incorporated in the user generated content, comprising:
providing a content catalog accessible via a storage device;
creating user generated content incorporating content from the content catalog via a user interface dynamically generated by a user generated content creation system configured to communicate with the storage device;
storing information indicative of the created user generated content and content from the content catalog incorporated in the user generated content in a database; and
dynamically generating a user interface using a content distribution platform configured to communicate with the storage device, where the user interface provides access to the stored user generated content and information related to content that is incorporated within the user generated content.
